(19) United States
(12) Patent Application Publication
(10) Pub. No.: US 2007/0094654 A1
(43) Pub. Date: Apr. 26, 2007

(54) Updating rescue software

(75) Inventor: Mihai Costea, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/254,833

(22) Filed: Oct. 20, 2005

(51) Int. Cl. G06F 9/44

(52) U.S. Cl. 717/168

(57) ABSTRACT

The present invention causes rescue software to be updated when a secondary operating system is “booted” from a rescue disk. Aspects of the present invention may cause a computer to be “booted” using the rescue software when a user turns on a computer. Once the computer is booted using the rescue software, a source where a software update to the rescue software may be obtained is identified. Then, a determination is made regarding whether the software update originates from a trusted entity. In instances when the software update originates from a trusted entity, the rescue software is updated with one or more software updates.

### BACKGROUND

For as long as computers have been in existence they have been notorious for failing. As a result, system administrators and other users have needed to be involved with disaster recovery to diagnose problems when a failure in the computer occurs. Such failures negatively impact the user experience because they may cause computer lock-ups and crashes that waste resources and time. However, some types of failures may be highly inconvenient, such as failures that prevent the computer from booting to an operating system when the computer is started.

An operating system controls and manages the resources of a computer. Typically, execution of an operating system is initiated upon power-on or reset of a computer by a sequence of events known as “bootstrapping” or “booting.” The operating system is “booted” by execution of a portion of code stored in a predetermined location on a primary storage medium (e.g., hard drive) that is typically known as a boot sector. Moreover, a boot sector is typically in an area of memory known as a “boot partition” that is not accessed by other components of an operating system. In a healthy computer, after performing certain functions necessary for the computer to start-up, the boot code transfers control of the computer to the operating system so that application programs may perform tasks desired by users.

If the operating system fails to boot, determining the cause of the failure and/or recovering from the failure may be time-consuming and difficult since any diagnostic capability built into the operating system is not available. Moreover, typically, users do not have multiple operating systems installed on the computer from which diagnostics of the failure may be performed. One way to diagnose and potentially recover from a failure is to cause the computer to boot from a non-primary storage medium. For example, “rescue disks” have been developed and packaged with computers to assist users in diagnosing and recovering from a failure. In a Windows operating system available from Microsoft® Corporation, the presence of a floppy diskette in the “A” drive causes the system to attempt to boot from the “A” drive. Thus, if a failed system boot from the primary storage medium (e.g., hard drive) occurs, the user may turn off the computer, insert a diskette into the “A” drive and attempt a reboot. Rescue disks contain a variety of different software components such as boot code and various utility programs for diagnosing the cause of the failure and recovering from the failure. Traditionally, rescue software on the rescue disks attempts to diagnose unintentional failures. In this regard, the recovery software attempts to identify how data that is used to boot the operating system became corrupted, such as identifying invalid CMOS settings, searching for corrupted drive partitions, checking for system file integrity, and the like.

Fortunately, as computer technology has continued to improve, the number of unintentional failures that occur when booting a computer has declined. However, intentional failures caused by malware that prevents a computer operating system from being booted are increasingly prevalent. Those skilled in the art and others will recognize that malware comes in the different forms, including, but certainly not limited to, computer viruses, computer worms, system component replacements, denial of service attacks, even misuse/abuse of legitimate computer system features, all of which exploit one or more computer system vulnerabilities for illegitimate purposes. While those skilled in the art will recognize that the various computer malware is technically distinct from one another, for purposes of the present invention and for simplicity in description, all malicious computer programs that spread on computer networks, such as the Internet, will be generally referred to hereinafter as computer malware or, more simply, malware.

A traditional defense against computer malware and, particularly, against computer viruses and worms, is antivirus software that is available from numerous software vendors. Most antivirus software identifies malware by matching patterns within data to what is referred to as a “signature” of the malware. For example, when a malware is identified “in the wild,” a hash function may be used to process the malware to generate a unique signature. Then, when a scan by antivirus software is scheduled to occur, signatures generated from known malware are compared to incoming data on a computer to determine whether the data is malware.

Those skilled in the art and others will recognize that, antivirus software has been incorporated into rescue disks to identify and clean a malware from the computer that is the source of a failure. However, in order to identify the most recent malware and the most likely source of a failure, up-to-date malware signatures need be available to the antivirus software that is incorporated into the rescue software. Stated differently, rescue disks are typically created and made available when a consumer purchases a computer. However, in order to identify new malware that is a likely source of a failure, the rescue software would benefit from the most recently created malware signatures.

While specific disadvantages of existing systems have been illustrated and described in this Background Section, those skilled in the art and others will recognize that the subject matter claimed herein is not limited to any specific implementation for solving any or all of the described disadvantages.

### SUMMARY

Aspects of the present invention are directed at securely updating rescue software that is designed to identify a source that caused a computer to become corrupted. In one exemplary embodiment, a method is provided that causes the computer to be “booted” using rescue software. Then, a source where a software update to the rescue software may be obtained is identified which may include but is not limited to, a network location, an external storage device, and/or a primary or secondary storage medium. Once a source of the software update has been identified, a determination is made regarding whether a software update originates from a trusted entity. If the software update originates from a trusted entity, the method causes the rescue software to be updated using the software update.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary networking environment with computers that contain components for securely updating rescue software on a computer;

FIG. 2 is a block diagram of an exemplary secondary storage medium with software components capable of identifying a source that caused a computer to become corrupted; and

FIG. 3 shows a flow diagram of an exemplary routine for securely updating rescue software.

### DETAILED DESCRIPTION

The present invention may be described in the general context of computer-executable instructions, such as program modules, being executed by a computer. Generally described, program modules include routines, programs, widgets, objects, components, data structures, and the like that perform particular tasks or implement particular abstract data types. The present invention may also be practiced in distributed computing environments where tasks are performed by remote processing devices that are linked through a communications network. In a distributed computing environment, program modules may be located on local and/or remote computer storage media.

Generally described, a method, software system, and computer-readable medium are provided for updating rescue software to identify a source that caused a computer to become corrupted. Aspects of the present invention may cause a computer to be “booted” using the rescue software when a user turns on a computer. Once the computer is booted using the rescue software, a source where a software update to the rescue software may be obtained is identified. Then, a determination is made regarding whether the software update originates from a trusted entity. In instances when the software update originates from a trusted entity, the rescue software is updated with one ore more software updates.

While aspects of the present invention will primarily be described in the context of obtaining and installing an update to antivirus software for the purpose of identifying a malware on a computer, those skilled in the relevant art and others will recognize that aspects of the invention are also applicable to other areas than those described. In any event, the following description first provides an overview of an environment and system in which aspects of the invention may be implemented. Then, a method that implements aspects of the invention is described. However, the illustrative examples provided herein are not intended to be exhaustive or to limit the claimed subject matter to the precise forms disclosed. Similarly, any steps described herein may be interchangeable with other steps or combinations of steps in order to achieve the same result.

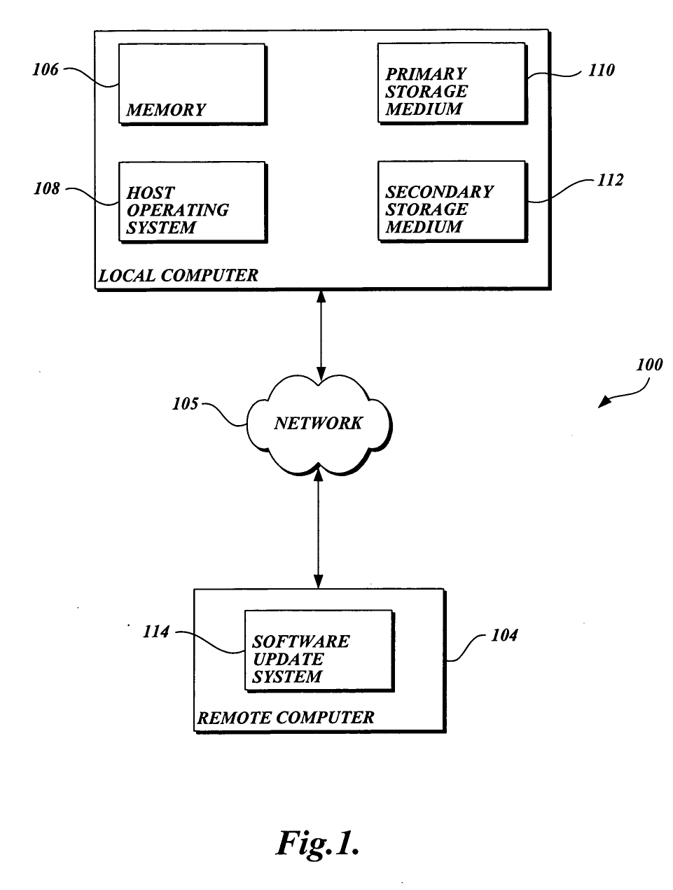

Now with reference to FIG. 1 a brief, general description of a networking environment 100 in which aspects of the present invention may be implemented will be described. As illustrated in FIG. 1, the networking environment 100 in this example is comprised of two computers, namely, the local computer 102 and the remote computer 104. Moreover, the local computer 102 is configured to communicate with the remote computer 104 via the network 105 which may be implemented as a Local Area Network (“LAN”), Wide Area Network (“WAN”), or the global network commonly known as the Internet. As known to those skilled in the art and others, the computers 102 and 104 illustrated in FIG. 1 may be configured to exchange files, commands, and other types of data over the network 105. However, since protocols for network communication such as TCP/IP are well known to those skilled in the art of computer networks, those protocols will not be described here.

Those skilled in the art and others will recognize that the local and remote computers 102 and 104 may be any one of a variety of devices including, but not limited to, personal computing devices, server-based computing devices, mini- and mainframe computers, laptops, personal digital assistants (“PDA”), or other electronic devices having some type of memory. For ease of illustration and because it is not important for an understanding of the present invention, FIG. 1 does not show the typical components of many computers, such as a CPU, keyboard, a mouse, a printer, or other I/O devices, a display, etc. However, as illustrated in FIG. 1, the local computer 102 does include a memory 106, a host operating system 108, a primary storage medium 110, and a secondary storage medium 112. Moreover, the remote computer 104 may contain some of the same components as the local computer 102. However, since those components are not necessary for an understanding of the claimed subject matter they are not depicted in FIG. 1 or described in the accompanying text. In any event, the remote computer 104 depicted in FIG. 1 does contain a software update system 114 which may be accessed by the local computer 102 via the network 105.

As illustrated in FIG. 1, the local computer 102 includes a memory 106 that may be volatile or nonvolatile memory, such as Read Only Memory (“ROM”), Random Access Memory (“RAM”), or other storage that is readily accessible to a CPU (not illustrated) on the local computer 102. Those skilled in the art and others will recognize that ROM and RAM typically contain data and/or program modules that are immediately accessible to and/or currently being operated on by a CPU.

As further illustrated in FIG. 1, the local computer 100 includes a primary storage medium 110 and a secondary storage medium 112 that may be any available media accessible by the local computer 102 and includes both volatile and nonvolatile media and removable and non-removable media. By way of example and not limitation, the primary storage medium 110 and the secondary storage medium 112 may be volatile or nonvolatile, removable or nonremovable, implemented using any technology that is capable of storing information such as, but not limited to a hard drive, CD-ROM, DVD, or other disk storage, magnetic cassettes, magnetic tape, magnetic disk storage, optical storage, or any other media that can be used to store the desired information and may be accessed by the local computer 102 even through a computer network. Combinations of any of the media described above should also be included within the scope of a storage medium. Typically, the primary storage medium 110 on a computer is a device, such as a hard drive, that contains program modules including the “boot” code that initiates execution of the host operating system 108. Conversely, the secondary storage medium 112 is typically a portable storage media that is accessed using a drive, such as a CD-ROM drive. However, these examples should be construed as exemplary and not limiting. In other embodiments, the secondary storage medium 112 may be included as part of the same device as the primary storage medium 110. For example, the secondary storage medium 112 could be a “non-boot” partition on the same device as the primary storage medium 110. Thus, the component architecture of the local computer 102 illustrated in FIG. 1, should be construed as exemplary and not limiting.

As illustrated in FIG. 1, the local computer 102 includes the host operating system 108 which may be a general-purpose operating system, such as a Microsoft® operating system, UNIX® operating system, or Linux® operating system. Alternatively, the host operating system 108 may be a specialized operating system designed specifically for a computer that maintains non-generic hardware. In any event, those skilled in the art and others will recognize that the host operating system 108 controls the general operation of the computer 102 and is responsible for executing application programs.

Typically, execution of an operating system such as the host operating system 108 is initiated upon power-on or reset of a computer by a sequence of events known as booting. In this regard, the host operating system 108 is booted by execution of a portion of code stored on the primary storage medium 110. In a healthy computer, after performing certain booting functions, control of the computer 102 is transferred to the host operating system 108. More specifically, program code that implements the host operating system 108 is loaded from the primary storage medium 110 into the memory 106 of the computer 102 which is accessible to a CPU. Once accessible to the CPU, program code implemented by the host operating system 108 controls and manages the execution of application programs installed on the local computer 102. However, in some instances, the local computer 102 may be unable to “boot” the host operating system 108 either because data has been inadvertently corrupted or because malware is preventing execution of the boot code. Moreover, in other instances, a user may suspect that the computer 102 is infected with a type of malware that corrupts the host operating system 108 and is therefore not detectable to antivirus software. In any event, the user may want to perform diagnostics on the computer 102 for determining whether the computer 102 was corrupted.

Those skilled in and others will recognize that systems have been developed to allow diagnostics to be performed on the local computer 102 when an operating system is unable to boot or is infected with malware that is not identified by antivirus software. One way to diagnose and potentially recover from a failure or identify malware is to cause the computer to boot from a the secondary storage medium 112. For example, rescue disks have been developed and packaged with computers to assist users in diagnosing and recovering from a failure. In this regard, a user may insert a floppy disk, CD-ROM, DVD-ROM, or other storage medium into the local computer 102. In this instance, when the local computer 102 is powered on, a secondary operating system that is stored on the secondary storage medium 112 is booted and manages execution of programs on the local computer 102. As described in further detail below, the secondary operating system may cause utilities stored on the secondary storage medium 112 (e.g., rescue disks) to perform an analysis of the program code to identify a source that is corrupting the host operating system 108.

Traditionally, recovery software provided on a rescue disk attempts to diagnose unintentional failures. Unfortunately, as mentioned previously, the source of corruption that prevented the host operating system 108 from booting may be a malware that was spread to the local computer 102 over a communication network. Moreover, malware as the source of corruption may be particularly troublesome since some malware implement self-preservation techniques designed to prevent removal of the malware. For example, two malware processes may be used to implement a self-preservation technique. In this instance, a first process implements the functionality of the malware and the second process monitors the status of the first process. The second process remains dormant until a command to terminate the first process is issued. Then the second process causes the computer to become infected again after the first process terminates. Also, increasingly, malware is being distributed with one or more programs specifically designed to conceal malware from antivirus software. For example, a RootKit is a malware that corrupts an operating system and prevents the detection of other malware by acting as a “man-in-the-middle,” monitoring and altering communications between an operating system and antivirus software. In this regard, if an application program, such as an antivirus software attempts to list the contents of a directory containing one or more files used by a malware, then the RootKit will censor the file name from the list. Similarly, a RootKit may hide entries in the system registry, process lists and the like, thereby controlling access to all of the information that the RootKit wants hidden. In some instances, when a RootKit is infecting a computer, antivirus software is unable to identify the RootKit since it relies on resources provided by an operating system. As a result, the only means available to a user for detecting the RootKit may be rescue software that does not rely on resources provided by a corrupted host operating system.

Those skilled in the art and others will recognize that, antivirus software has been incorporated into rescue disks to identify and clean malware from the computer. However, in order to identify the most recently developed malware and malware that hides and/or performs self preservation techniques, up-to-date antivirus software with the most recently created updates needs to be used to identify and recover from an infection. Since, rescue disks are typically created and made available when a consumer purchases a computer, a need exits to update rescue software with the most recently created malware signatures, cleaning routines, troubleshooters, and any other software that may assist in recovering from a failure or identifying and removing a malware from a computer.

In one embodiment, aspects of the present invention provide a way to update software on “rescue disks” which may be contained on any type of medium, such as, but certainly not limited to, CD-ROM, DVD-ROM, floppy disks, USB hard drive, secondary hard disk partition and the like to recover from a failure or identify and clean a computer that is infected with malware. In this regard, when a computer is booted using a rescue disk that contains software routines implemented by the present invention, the software routines search for a source from which to obtain the most recently created software updates. For example, in the context of FIG. 1, software routines on the secondary storage medium 112 may be used to boot the computer 102 to a secondary operating system. Then utilities on the secondary storage medium 112 are used to connect the local computer 102 to the network 105 where one or more software updates may be accessed from the remote computer 104. In this instance, software updates provided by the software update system 114 that identify and clean recently identified malware is transmitted over the network 105 to the local computer 102. These software updates are used to identify the source of an infection and/or corruption on the local computer 102 and perform any corrective actions needed to boot the local computer 102 to the host operating system 108.

FIG. 1 is a simplified example of a networking environment 100 with computers 102 and 104 that are capable of performing the functions of the present invention. However, actual embodiments of the networking environment 100 and the computers 102 and 104 may have additional components not illustrated in FIG. 1 or described in the accompanying text. Also, FIG. 1 shows one component architecture for the computers 102 and 104 that may be used to implement the present invention. In this regard, for the sake of convenience, FIG. 1 illustrates computers 102 and 104 that are usable in the networking environment 100 in which complementary tasks may be performed by remote computers linked together through the communication network 105. However, those skilled in the art and others will appreciate that the present invention may be practiced with many other computer system configurations. For example, the present invention may be practiced in a computer that operates in a stand-alone environment. As described in more detail below, when implemented in a stand-alone environment, software updates may be obtained from a storage medium that is available on the computer 102 so that network communication may not be needed.

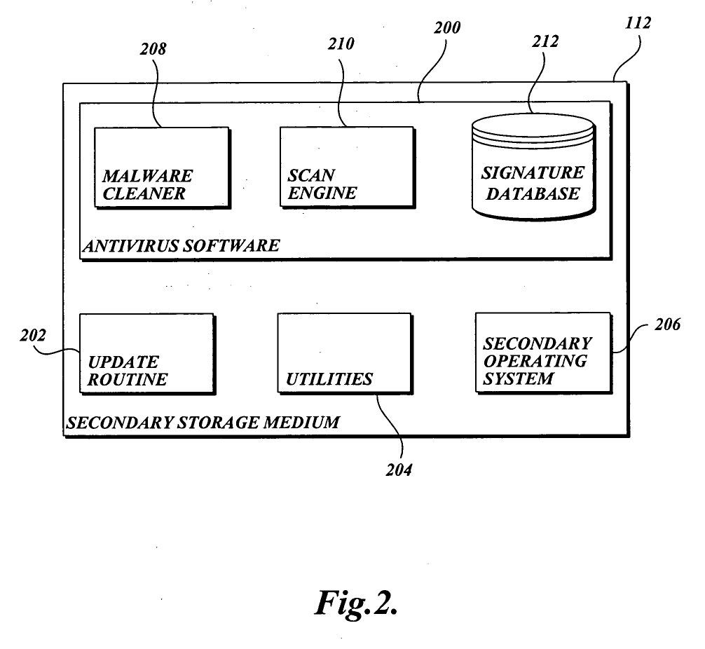

Now with reference to FIG. 2 software components that may be included on the secondary storage medium 112 that is also depicted in FIG. 1 to identify the source of corruption and/or recover from a failure will be described. As illustrated in FIG. 2, the secondary storage medium 112 (hereinafter referred to as the “rescue disk”) contains a number software components including antivirus software 200, an update routine 202, utilities 204, and a secondary operating system 206. Moreover, the antivirus software 200 depicted in FIG. 2 includes a malware cleaner 208, a scan engine 210, and a signature database 212.

Those skilled in the art and others will recognize that a rescue disk is typically implemented as a “bootable” image. In this regard, if a user turns on a computer when a rescue disk is inserted into a drive on the computer, the rescue disk causes the sequence of steps for “booting” the computer to be executed. During the boot process, program code that implements the secondary operating system 206 is loaded from the rescue disk into the memory of the computer. Then, control of a computer is transferred from the boot code to the secondary operating system 206 that is typically a scaled-down version of a host operating system. As such, the secondary operating system 206 manages resources of a computer for the purpose of executing application programs to identify the source and/or recover from a failure.

In one embodiment, the secondary operating system 206 may cause the antivirus software 200 to be loaded into the memory of a computer and executed. Generally described, the antivirus software 200 searches for malware that is resident on a computer. In this regard, the antivirus software 200 includes a scan engine 210 designed to detect data that is characteristic of malware. Many different software vendors include a scan engine or similar software module in antivirus software. One known technique employed by some existing scan engines that is used to identify data characteristic of malware includes obtaining a copy of the malware “in the wild.” Then the data that implements the malware is processed with a hash function that converts the data, or a characteristic subset of the data, into a signature that uniquely identifies the malware. The scan engine 210 illustrated in FIG. 1 may employ this technique of scanning a file for a malware signature. In this regard, the scan engine 210 will access the signature database 212 which contains signatures created from known malware. Thus, for the antivirus software 200 to identify the most recently developed malware, the signature database 212 needs to contain “up-to-date” malware signatures. Although specific examples of malware detection techniques have been described, it should be well understood that the examples provided herein should be construed as exemplary and not limiting, as the scan engine 210 may employ any one of a number of existing, or yet to be developed, malware detection techniques without departing from the scope of the claimed subject matter.

When malware is identified as being resident on a computer, a component of the antivirus software 200 known as the malware cleaner 208 is responsible for removing the malware from the computer. Routines provided by the malware cleaner 208 may perform any number of actions, including but certainly not limited to (1) “killing” or terminating processes associated with the malware, (2) removing malware-generated entries in configuration files such as the system registry, and/or (3) deleting files that contain malware program code and data. Since an increasing number of malware hide or otherwise use self-preservation techniques, the malware cleaner 208 may also be need to be updated with the most recently developed cleaning routines.

In one embodiment, the secondary operating system 206 causes the utilities 204 to be loaded into the memory of a computer and executed. The utilities 204 may include programs for diagnosing and recovering from a failure in booting a host operating system. Moreover, the utilities 204 may include troubleshooters, diagnostic tools, management tools (e.g., editors to change entries in the registry or browse the file system), repairing tools (e.g., programs for boot sector repairing and/or registry file checker, etc.). Since the functions performed by some of the utilities 204 are not important for an understanding of the present invention, they will not be described in further detail here. However, it should be well understood that the utilities 204 may be used by aspects of the present invention to perform certain actions on a computer such as establishing a network connection. Moreover, it should be well understood that a software update may be obtained for any of the software components included on a rescue disk including the utilities 204.

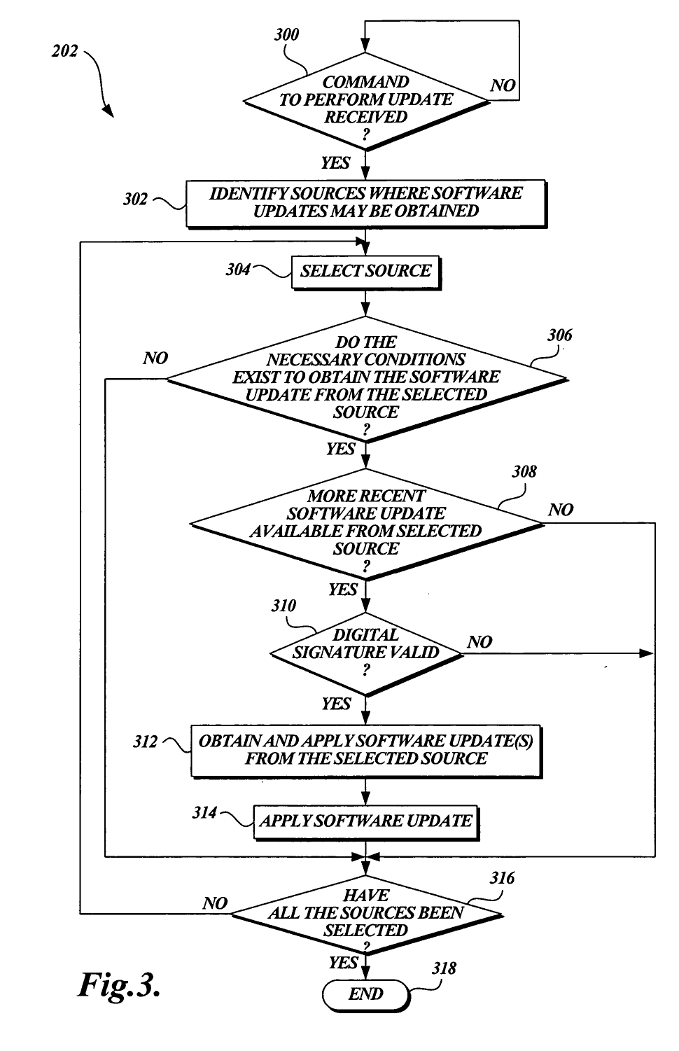

As will be better understood from the description provided below with reference to FIG. 3, certain aspects of the present invention are implemented in the update routine 202. Since functions and different embodiments of the update routine 202 are described below with reference to FIG. 3, a detailed description of the routine 202 will not be provided here. However, generally described, the update routine 202 contains logic for dynamically updating software that is included on a rescue disk. In one embodiment, the update routine 202 is used to update the antivirus software 200 with the most recent malware signatures and cleaning routines. As a result, a malware that is infecting a host operating system may be identified and removed from the computer thereby allowing normal operations to resume in the host operating system.

Now with reference to FIG. 3, the update routine 202 that is also depicted in FIG. 2 will be described in further detail. As a preliminary matter, before the update routine 202 may begin executing, an operating system is “booted” from a rescue disk and causes program code (libraries, modules, etc.) that implements the update routine 202 to be loaded into computer memory in anticipation of being executed. Moreover, other software modules from the rescue disk may also be loaded into computer memory in anticipation of being updated when the update routine 202 executes. Those skilled in the art and others will recognize that an operating system manages the process of loading necessary program code into memory when the program code is needed. Moreover, the operating system will also “swap” program code in and out of memory as needed to accommodate the memory requirements of other software modules.

A user may boot from a rescue disk for any number of different reasons. For example, a primary operating system may be corrupted resulting in a computer being unusable without the diagnostic capability of the rescue software. Also, as mentioned previously, a RootKit or other malware that employs stealth techniques may be preventing antivirus software on a computer from identifying a malware. In either instance, a user may need to update the rescue software in order to resume normal operations of the computer.

Generally described, software modules on a rescue disk may be categorized as either potentially needing or not needing a software update. In the context of the software system illustrated in FIG. 2, the secondary operating system 206 will typically be stable and will not need a software update. Conversely, the antivirus software 200 and the utilities 204 may benefit from software updates in order to identify recently created malware. Frequently, rescue disks are provided on a read-only media such as a CD-ROM or DVD-ROM in which software updates may not be written to the media. Thus, the update routine 202 causes software updates to be applied to the version of the rescue software that is loaded in the computer memory. Then, components of the rescue software may be executed to identify the source of corruption and/or take remedial action so that a host operating system may be booted.

As illustrated in FIG. 3, the update routine 202 begins at block 300 where a command to perform an update to rescue software is received. When decision block 300 is reached, an operating system associated with rescue software was booted and is available to execute programs. In one embodiment of the present invention, when the user causes a secondary operating system to boot, the user is presented with a menu that contains a plurality of selectable menu items. One of the available menu items requests input regarding whether updates to the rescue software should be obtained. In this instance, a command is generated, at block 300, when the user selects this available menu item. However, those skilled in the art and others will recognize that the command to update the rescue software may be generated at block 300 using other techniques. For example, a secondary operating system may be configured to automatically generate the command whenever software updates to the rescue software are available. In this instance, input on behalf of the user is not needed as the command is generated automatically.

At block 302, the update routine 202 identifies one or more sources where software updates to the rescue software may be obtained. In one embodiment, the update routine 202 automatically searches a plurality of pre-determined locations for software updates that may be applied to software components on a rescue disk. The pre-determined locations include, but are not limited to, network locations associated with a trusted entity and storage mediums and/or drives on the computer in which the secondary operating system was booted. However, a source where a software update is accessible may be identified by the user in instances when the software updates are not being obtained automatically.

Numerous vendors provide software to users that may need to be updated to protect the computer from malware or otherwise prevent a failure from occurring. Increasingly, vendors are making software updates available from a network location on the Internet. In one embodiment of the present invention, the source where a software update may be obtained is a network location associated with a software vendor or other trusted entity. In this regard, the address of the network location where the software update may be obtained is “hard-coded” into the update routine 202. However, the network location may be identified using other techniques than those described above. For example, in an alternative embodiment, the rescue software searches a storage medium on the computer to identify the antivirus software that is installed on the computer. In this instance, when a vendor that provides the antivirus software is identified, a list is accessed that associates vendors with network locations where software updates from the vendors may be obtained.

Another source where software updates may be obtained is a storage medium on the computer in which the secondary operating system was booted. For example, most users install and regularly update antivirus software on their computers. Since, rescue software is only “up-to-date” when a user takes possession of a computer, malware signatures already stored on the computer may be more “up-to-date” than the signatures that are available in the rescue software. Thus, one potential source for software updates is a primary storage medium on the computer in which the secondary operating system was booted. Moreover, other storage mediums on the computer may also be a source for software updates. For example, an organization may experience a system wide failure in which multiple computers need to be booted from rescue software. In this instance, the organization may provide software updates on an external storage device, such as a USB drive, a FireWire device, etc.

At block 304, the update routine 202 selects a source where a software update will be obtained. As mentioned previously with reference to block 302, several possible sources for software updates exist that may be selected at block 304, including, but not limited to, a network location and/or storage mediums connected to a computer. In one embodiment, the source that is selected at block 304 is predetermined; for example, when a network address is “hard-coded” into the rescue software. In other embodiments, the source of a software update is selected manually by the user when a network location or path on a storage medium is identified.

As illustrated in FIG. 3, at decision block 306, the update routine 202 determines whether the necessary conditions exist to obtain the software update from the selected source. The selected source may be a remote computer that is accessed from a location on a communication network identified with an address such as a Uniform Resource Locator (“URL”) address. In this example, in order to obtain a software update, the computer in which the secondary operating system was booted will communicate with the remote computer over the communication network. Thus, when the selected source is accessed over a communication network, the update routine 202 determines whether a communication link is capable of being established. In this regard, those skilled in the art and others will recognize that rescue software may be configured with software components such as drivers, programs, and the like for establishing a communication link with a remote computer. In this exemplary embodiment, the update routine 202 determines, at block 306, whether a communication link may be established with a remote computer. However, those skilled in the art and others will recognize that other necessary conditions may be checked, at block 306, and the exemplary condition described above should be construed as exemplary and not limiting.

At decision block 308, the update routine 202 determines whether a more recent software update is available from the selected source. In accordance with one embodiment, software components that are capable of being updated are assigned a version number and a digital signature. Those skilled in the art and others will recognize that the version number is merely a numeric value that identifies a version of a component of software. Typically, higher numeric values are assigned to newer versions of the software. Moreover, a digital signature is a sequence of code that uniquely identifies a software update source which may be used to ensure that data provided in a software update remains in an original state. In any event, the update routine 202 determines whether a newer version of a software update is available, at block 308, by comparing version numbers of the software component(s). More specifically, the version number of the software component that is provided by the rescue software is compared to the version number of the software component that is available from the source selected at block 304. If a newer version of the software component(s) is not available, the update routine 202 proceeds to block 316 described below. Conversely, if a newer version of the software component(s) is available, the update routine 202 proceeds to block 310.

At decision block 310, the update method 202 determines whether the digital signature of the software component available from the selected source is valid. If block 310 is reached, a software update to the rescue software is available from the selected source. In this instance, the update method 202 authenticates the software update by analyzing the digital signature associated with the software update. However, since authenticating a digital signature may be performed using techniques that are generally known in the art, further description of the techniques used at block 310 to determine if the signature is valid will not be described in further detail here. In any event, if the signature is not valid, the update method 202 proceeds to block 316 described below. Conversely, if the signature is valid, the method 202 proceeds to block 312.

As illustrated in FIG. 3, at block 312, the update method 202 obtains a software update from the source selected at block 304. In one embodiment, obtaining the software update includes downloading a file from a remote computer using a network connection. However, in instances when the source of the software update is on the local computer, obtaining a software update, at block 312, may be performed by copying the update from a storage medium or drive. Moreover, those skilled in the art and others will recognize that obtaining a software update may be performed, at block 304, using other techniques.

At block 314, the update method 202 causes the software update obtained at block 312 to be applied to the rescue software that caused the computer to boot. In some instances, applying a software update may be performed by storing the update in a specified location in the memory of the computer. For example, as described previously, one type of software update uses recently developed malware signatures that allow antivirus software to identify new malware. Applying this type of software update may be performed by saving the recently developed malware signatures to a location in memory in which a database is loaded. Alternatively, applying the software update may include executing program code that causes the software update to update data that is loaded in memory on the computer. Typically, application programs and software updates are distributed with an “installer” program that performs the necessary actions to update software in this way. In this embodiment, applying the software update may be performed, at block 314, by initiating execution of an installer program that is distributed with a software update.

At decision block 316, the update method 202 determines whether all of the potential sources of software updates have been selected. In one embodiment, the update method 202 is configured to automatically obtain and/or install software updates that are accessible from predetermined locations such as a network address. In this instance, the method 202 may search multiples sources in order to obtain the most recently developed software updates. However, as mentioned previously, obtaining a software update may be performed at the direction of the user. In this instance, the user may or may not attempt to obtain software updates from more than one source. In any event, if additional sources will be selected, the update method 202 proceeds back to block 304 and blocks 304 through 316 repeat until all the sources have been selected. Conversely, if additional sources of software updates will not be selected, the update method 202 proceeds to block 318, where it terminates.

While illustrative embodiments have been illustrated and described, it will be appreciated that various changes can be made therein without departing from the spirit and scope of the invention.

The embodiments of the invention in which an exclusive property or privilege is: claimed are defined as follows:

1. A method of updating rescue software that includes an operating system for managing execution of programs, the method comprising:
(a) identifying a source where a software update to the rescue software may be obtained;
(b) determining whether the software update originates from a trusted entity; and
(c) if the software update originates from a trusted entity, applying the software update to the rescue software.

2. The method as recited in claim 1, further comprising if the software update does not originate from a trusted entity, preventing the software update from being applied to the rescue software.

3. The method as recited in claim 1, further comprising causing an installer program to install the software update on the computer.

4. The method as recited in claim 1, wherein identifying a source where a software update may be obtained includes determining whether the necessary conditions exist to obtain the software update from the trusted entity.

5. The method is as recited in claim 4, wherein the source is a location on a communication network and determining whether the necessary conditions exist to obtain the software update includes determining whether the computer is connected to the communication network.

6. The method as recited in claim 1, wherein identifying a source where a software update to the rescue software may be obtained includes determining whether a storage medium on the computer contains more recently developed malware signatures than the rescue software.

7. The method as recited in claim 6, wherein determining whether a storage medium on the computer contains more recently developed malware signatures includes comparing version numbers associated with a software component that contains the malware signatures.

8. The method as recited in claim 1, wherein the software update contains cleaning routines for removing malware from the computer.

9. The method as recited in claim 1, wherein determining whether the software update originates from a trusted entity includes:
(a) assigning a digital signature to one more components of the rescue software; and
(b) determining whether a digital signature received from a trusted entity is valid.

10. The method as recited in claim 1, wherein applying the software update includes downloading the software update from a location on a communication network.

11. A software system for updating rescue software that identifies malware on a computer, the rescue software comprising:
(a) an operating system for managing resources of the computer and executing application programs;
(b) a scan engine operative to search for data that is characteristic of malware;
(c) a signature database for storing signatures that uniquely identify malware; and
(d) an update routine operative to obtain malware signatures from a trusted entity and cause the signatures to be stored in the signature database.

12. The software system as recited in claim 11, further comprising a malware cleaner that includes cleaning routines for removing malware from the computer; and
wherein the update routine is further configured to obtain malware cleaning routines from the trusted entity.

13. The software system as recited in claim 11, further comprising utilities that are operative to establish a network connection with a remote computer on a communication network.

14. The software system as recited in claim 11, wherein the update routine is further configured to determine whether the malware signatures originate from the trusted entity by obtaining a digital signature from the trusted entity and determining whether the signature is valid.

15. The software system is recited in claim 11, wherein the update routine is further configured to determine whether a version of the malware signatures that is available from the trusted entity is more recent than the version of the malware signatures that is provided in the rescue software.

16. A computer-readable medium containing computer-readable instructions which, when executed in a computer, performs a method of updating rescue software that includes an operating system for managing execution of programs, the method comprising:
(a) identifying a source where a software update to the rescue software may be obtained;
(b) determining whether the software update originates from a trusted entity, including:
(i) assigning a digital signature to a component of the rescue software; and
(ii) determining whether a digital signature assigned to a component of the rescue software that is available from a trusted entity is valid;
(c) if the software update originates from the trusted entity, applying the software update to the rescue software; and
(d) conversely, if the software update does not originate from the trusted entity, preventing the software update from being applied to the rescue software.

17. The computer-readable medium as recited in claim 16, wherein the software update obtained is available from the trusted entity includes one or more malware signatures.

18. The computer-readable medium as recited in claim 16, wherein the software update that is available from the trusted entity includes one or more cleaning routines for removing malware from the computer.

19. The computer-readable medium as recited in claim 16, wherein the source is a location on a communication network and determining whether the necessary conditions exist to obtain the software update includes determining whether the computer is connected to the communication network.

20. The computer-readable medium as recited in claim 16, wherein applying the software update includes:
(a) downloading the software update from a location on a communication network; and
(b) causing an installer program to update data in memory on the computer.
